(19) United States
(12) Patent Application Publication
(10) Pub. No.: US 2015/0277431 A1
(43) Pub. Date: Oct. 1, 2015

(54) SAW DATA ACQUISITION SYSTEM AND METHOD OF OPERATING A SAW

(71) Applicant: The M. K. Morse Company, Canton, OH (US)

(72) Inventor: Mark Alan Taylor, Marietta, GA (US)

(21) Appl. No.: 14/672,946

(22) Filed: Mar. 30, 2015

Related U.S. Application Data
(60) Provisional application No. 61/973,456, filed on Apr. 1, 2014.

(51) Int. Cl. G05B 19/4063

(52) U.S. Cl. CPC G05B 19/4063; G05B 2219/45144; G05B 2219/32128

(57) ABSTRACT

The saw data acquisition system and method of operating a saw employ sensors that detect specific data regarding a cutting operation. The system and method enable the saw operator to input data and display selected the data for the operator. Data that is detected by the sensors and which is input are collected and transmitted to a central processing location, acquired at the central processing location, and analyzed. The analysis enables optimum cutting parameters for a given cutting task, guidance regarding optimum operation and efficiency of the saw, information for improved blade design and manufacture, and optional remote monitoring capabilities of multiple saws, to be provided.

### CROSS-REFERENCE TO RELATED APPLICATIONS

This application claims the benefit of U.S. Provisional Patent Application Ser. No. 61/973,456, which was filed on Apr. 1, 2014.

### BACKGROUND OF THE INVENTION

1. Technical Field

The invention relates to industrial saws. More particularly, the invention relates to monitoring systems for industrial saws. Still more particularly, the invention is directed to a saw data acquisition system and method of operating a saw that desirably improve the operation and efficiency of one or more saws. The saw data acquisition system and method of operating a saw employ sensors that detect specific data regarding a cutting operation, enable the operator to input data, display selected the data for the operator, collect the data, transmit the data to a central processing location, acquire the collected data in the central processing location, and enable the data to be analyzed at the central processing location. Such data acquisition and analysis enable the saw data acquisition system and method of operating a saw to provide optimum cutting parameters for a given cutting task, guidance regarding optimum operation and efficiency of the saw, information for improved blade design and manufacture, and optional remote monitoring capabilities of multiple saws.

2. Background Art

Industrial saws are known in the art, and include saws such as band saws and circular saws. For the purpose of convenience, reference herein will be made to a saw using a band saw as an example, with the understanding that the invention applies to other types of industrial saws, such as circular saws.

An industrial band saw includes a tool carriage, which supports a saw blade. The saw blade is mounted on and driven by a pair of spaced-apart wheels that are enclosed in the tool carriage. A table supports a workpiece that is to be cut by the saw blade, and the workpiece is secured to the table by a clamp or vise. The carriage is vertically moveable relative to the table to enable the saw blade to advance through the workpiece as the blade cuts, and also to withdraw the blade from the workpiece when the cutting operation is complete.

In order to improve the efficiency of the cutting operation, simple local monitoring systems were developed in the prior art. Such systems sensed and displayed the speed of the saw blade, the position of the workpiece, and other basic parameters. Initial systems provided a real-time readout of these parameters on a display panel attached to the saw, which enabled the operator to observe the parameters and adjust the cutting operation as necessary.

As time progressed, prior art systems became more advanced to enable improved monitoring. Such improved prior art systems included sensors that were connected to a local computer. The local computer received input from the sensors and compared the measured parameters to one another. The computer then displayed improved real-time data for the machine operator to see, enabling the operator to adjust the cutting operation. The computer also locally stored the data.

While such prior art systems are satisfactory for their intended purposes, they only provide operational parameters to the operator to enable real-time adjustments to the cutting operation. Such systems lack the ability to sense certain parameters that are critical to long-term optimization of overall cutting operations, and to send the data regarding those parameters to a central processing location, where the parameters can be analyzed for recommendations regarding optimum efficiency and operation of the saw, and where remote monitoring of the cutting operation can be provided.

As a result, it is desirable to overcome the disadvantages of the prior art and provide a saw data acquisition system and method of operating a saw that enable input of data by an operator, suggest optimum cutting parameters for a given cutting task, employ sensors which detect and acquire specific data regarding the cutting operation, display sensor data to the operator, collect job run data from the operator, transmit collected data to a central processing location, acquire and process the data in the central processing location, optionally provide remote monitoring capabilities of multiple saws, and enable the data to be analyzed at the central processing location for guidance regarding optimum operation and efficiency of the saw. The present invention satisfies these needs, as will be described below.

### BRIEF SUMMARY OF THE INVENTION

An objective of the present invention is to provide a saw data acquisition system and/or a method of operating a saw that enable input of data by an operator and suggest optimum cutting parameters for a given cutting task.

Another objective of the present invention is to provide a saw data acquisition system and/or a method of operating a saw that employ sensors which detect and acquire specific data regarding the cutting operation, optionally display sensor data to the operator, collect job run data, transmit collected data to a central processing location, and acquire and process the data in the central processing location.

Yet another objective of the present invention is to provide a saw data acquisition system and/or a method of operating a saw that enable data to be analyzed at a central processing location for guidance regarding optimum operation and efficiency of the saw.

Still another objective of the present invention is to provide a saw data acquisition system and/or a method of operating a saw that optionally provide remote monitoring capabilities of multiple saws.

These objectives and others are obtained by the method of operating a saw of the present invention. In an exemplary embodiment of the invention, the method includes the steps of equipping a saw with at least one sensor, and acquiring data regarding the cutting operation using the at least one sensor. The acquired data is transmitted to a central processing location, and is acquired in the central processing location. The acquired data is analyzed, and recommendations for operation of the saw based on the analysis are generated. The recommendations are incorporated into operation of the saw to optimize the operation and efficiency of the saw.

These objectives and others are obtained by the saw data acquisition system of the present invention. In an exemplary embodiment of the invention, the system includes at least one sensor that is operatively connected to a saw. An interface panel is operatively connected to the saw, and a central processing location is provided. Means for transmitting data acquired by the sensor and the data that is input into the interface panel transmit the data to the central processing location. The central processing location includes a storage medium for storing the transmitted data. Means for analyzing the transmitted data analyze the data and provide recommendations for operation of the saw based on the analysis.

### BRIEF DESCRIPTION OF THE SEVERAL VIEWS OF THE DRAWINGS

The preferred embodiment of the present invention, illustrative of the best mode in which Applicants have contemplated applying the principles, is set forth in the following description and is shown in the drawings, and is particularly and distinctly pointed out and set forth in the appended claims.

FIG. 1 is a front elevational schematic view of an industrial band saw employing an exemplary embodiment of the saw data acquisition system of the present invention;

FIG. 2 is a schematic representation of the transmittal of data and acquiring of data by a central processing location in accordance with the exemplary embodiment of the saw data acquisition system of the present invention;

FIG. 3 is a schematic representation of data that may be input into the saw data acquisition system of the present invention;

FIG. 4 is a schematic representation of devices that may be employed as interface panels in the saw data acquisition system of the present invention;

FIG. 5 is a schematic representation of exemplary definitional data that may be input into the saw data acquisition system of the present invention;

FIG. 6 is a schematic representation of sensors, an interface panel, a local controller, and a central processing location of the saw data acquisition system of the present invention;

FIG. 7 is a schematic representation of information that is coordinated through an interface panel of the saw data acquisition system of the present invention;

FIG. 8 is a schematic representation of exemplary information regarding the material to be cut that is input into the saw data acquisition system of the present invention;

FIG. 9 is a schematic representation of the processing of exemplary material input information and the return of processing recommendations of the saw data acquisition system of the present invention;

FIG. 10 is a schematic representation of exemplary cutting blade information that is input into the saw data acquisition system of the present invention;

FIG. 11 is a schematic representation of exemplary job run event information that is input into the saw data acquisition system of the present invention;

FIG. 12 is a schematic representation of acquired sensor data that is measured by the saw data acquisition system of the present invention;

FIG. 13 is a schematic representation of the processing of exemplary data and monitoring, actuation of alerts, and/or analysis of the processed data of the saw data acquisition system of the present invention;

FIG. 14 is a schematic representation of exemplary remote monitoring of the saw data acquisition system of the present invention; and

FIG. 15 is a schematic representation of an exemplary data analysis of the saw data acquisition system of the present invention.

Similar numerals refer to similar parts throughout the drawings.

### DETAILED DESCRIPTION OF THE INVENTION

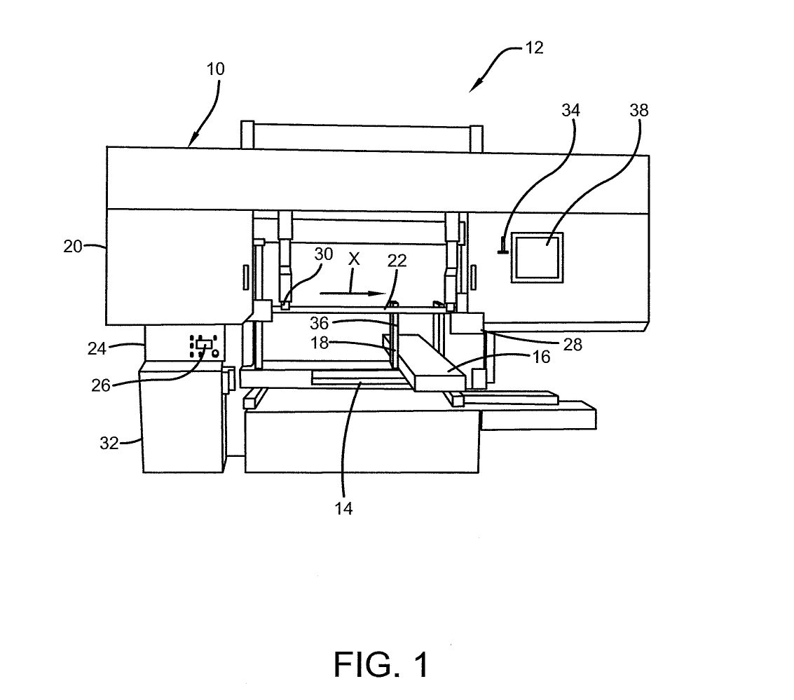

An industrial band saw 10, and an exemplary embodiment of the saw data acquisition system of the present invention, which is indicated generally at 12, are shown in FIG. 1 and now will be described. Industrial band saw 10 includes a table 14, which supports a workpiece 16 that is to be cut by the saw. A clamp or vise 18 secures workpiece 16 to table 14. A tool carriage 20 is mounted above table 14, and a drive motor (not shown) is mounted in the tool carriage. The drive motor is coupled to a driven wheel (not shown) and an idler wheel (not shown), which are spaced apart from one another and are rotatably mounted in carriage 20. An endless band saw blade 22 is mounted on the driven and idler wheels as known to those skilled in the art.

The driven wheel drives saw blade 22 in a direction indicated by arrow X, which is the direction of the cut in workpiece 16. Controls 26 on an interface panel 24 enable an operator to control the operation of saw blade 22 and the position of carriage 20. Carriage 20 is vertically moveable relative to table 14. During the cutting operation, the operator, using controls 26, actuates saw blade 22 and adjusts the position and movement of carriage 20 to enable the blade to cut and advance through workpiece 16. Once workpiece 16 has been cut, carriage 20 moves vertically upward and away from the workpiece, either by actuation of controls 26 by the operator, or by automatic control.

Saw data acquisition system 12 includes a traverse meter or encoder 28 that measures the feed rate of saw blade 22, which is the rate at which the saw blade advances vertically, also known as the traverse direction, through workpiece 16. System 12 also includes a speed sensor 30, which directly measures the linear speed of saw blade 22. An alternate structure and method for determining the linear speed of saw blade 22 is provided by use of a proximity sensor (not shown) mounted inside carriage 20 to detect the rotational speed of the driven wheel or the idler wheel and correlate the wheel rotational speed to the linear speed of the saw blade. In addition, system 12 includes an amperage meter 32, which measures the power input to the drive motor, and thus the power requirements of the drive motor during the cutting operation. System 12 further includes a temperature sensor 34 to sense air temperature adjacent workpiece 16, and a clamp sensor 36 to measure the width of clamp 18 to provide an indication of the size and shape of workpiece 16. Clamp sensor 36 may be an encoder or a linear variable differential transformer (“LVDT”), or other type of sensor known in the art that is capable of measuring the width of clamp 18.

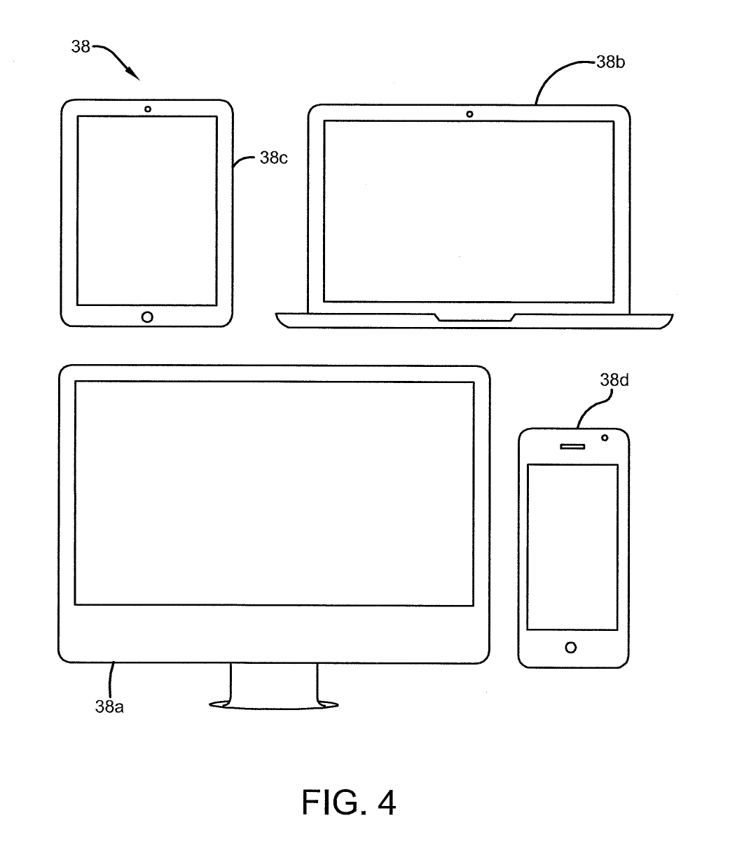

In order to enable an operator to input additional parameters, as will be described below, and to display data to enable the operator to monitor the operation of saw 10, an interface panel 38 is disposed adjacent the saw, such as by being mounted carriage 20. With additional reference to FIG. 4, interface panel 38 preferably is a computing device that acts as an operator-to-saw interface. For example, interface panel 38 may be a computer display 38a, a laptop computer 38b, a tablet computing device 38c, a smart phone 38d, or other hand-held consumer electronic device.

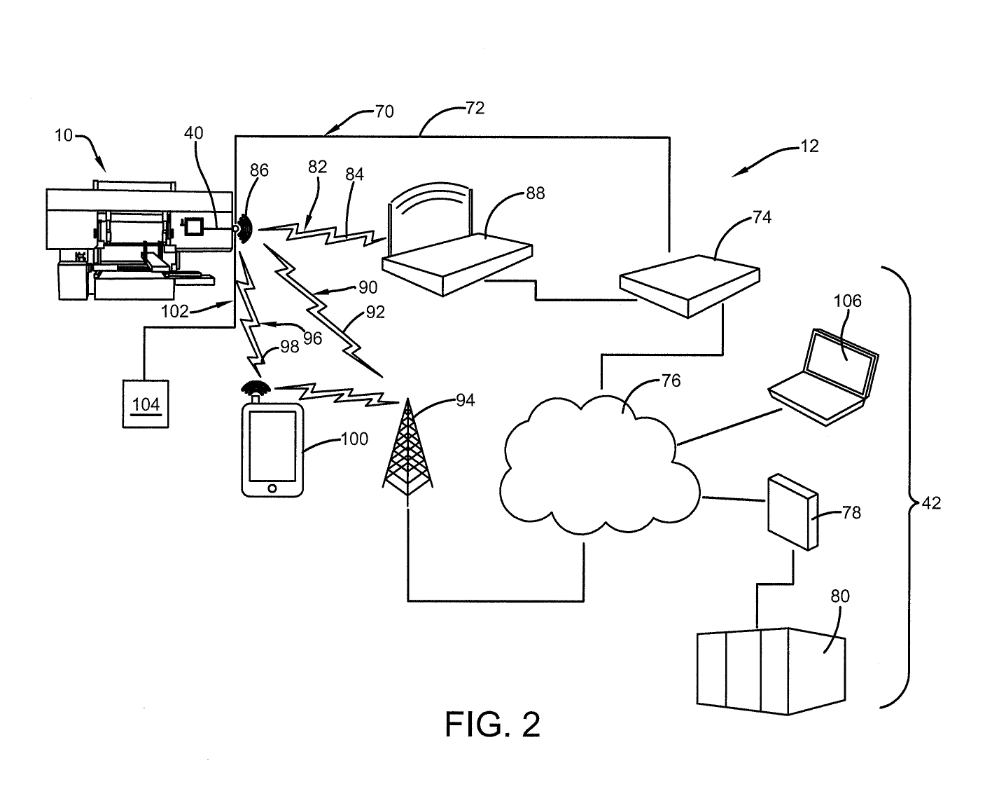

Interface panel 38, traverse meter 28, proximity sensor 30, amperage meter 32, temperature sensor 34, and clamp sensor 36, as well as any other sensors that are employed in saw data acquisition system 12, are electrically connected to a local controller 40 (FIG. 2) or central processing unit (“CPU”). It is to be understood that reference herein to the phrase electrically connected includes wired connections and wireless connections, and known to those skilled in the art.

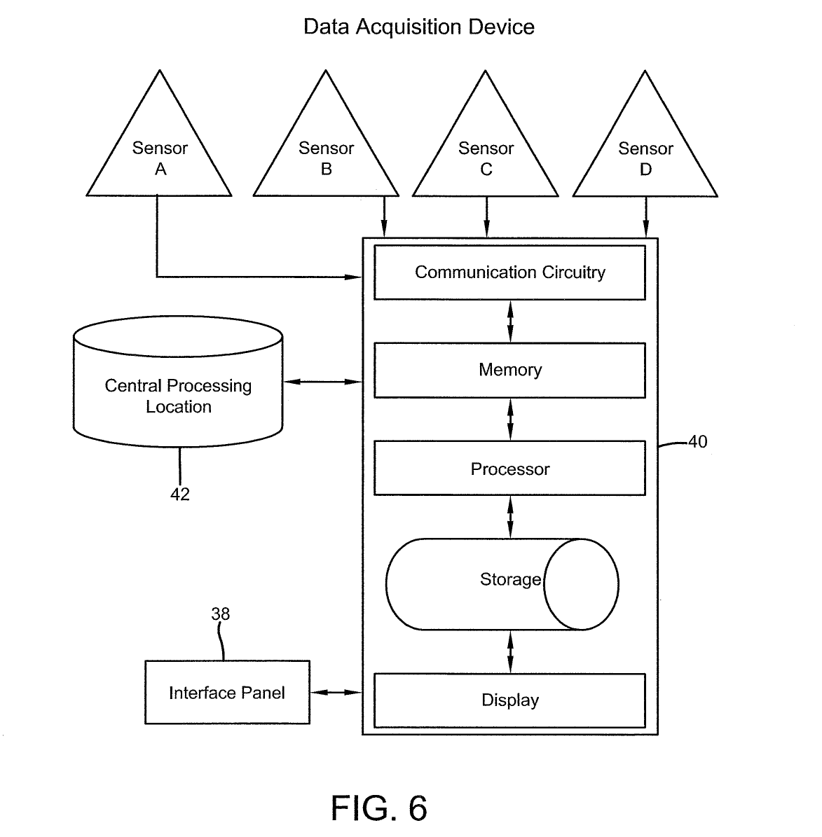

As shown in FIGS. 2 and 6, local controller 40 acquires, collects, processes and stores the above-described data and parameters, and any additional parameters that are input via interface panel 38, for transmittal to a central processing location 42. More particularly, sensors A, B, C, and D, as well as any number of additional sensors, are electrically connected to local controller 40, which is also electronically connected to interface panel 38. As will be described in greater detail below, saw data acquisition system 12 transmits the data from the controller 40 to a central processing location 42.

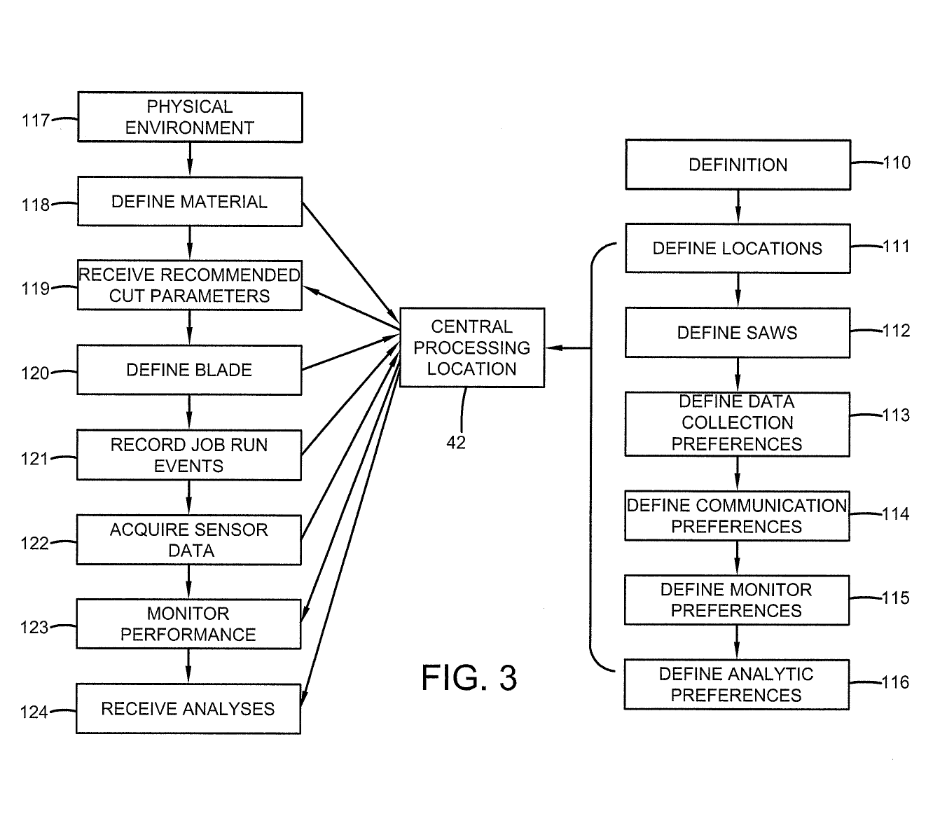

Turning now to FIG. 3, in order to deploy saw data acquisition system 12, preparatory setup of information at central processing location 42 preferably occurs. More particularly, data that includes preparatory definitions 110 are set and input into the processors, such as servers 80 (FIG. 2) at central processing location 42, or are set at another location and transmitted to the central processing location.

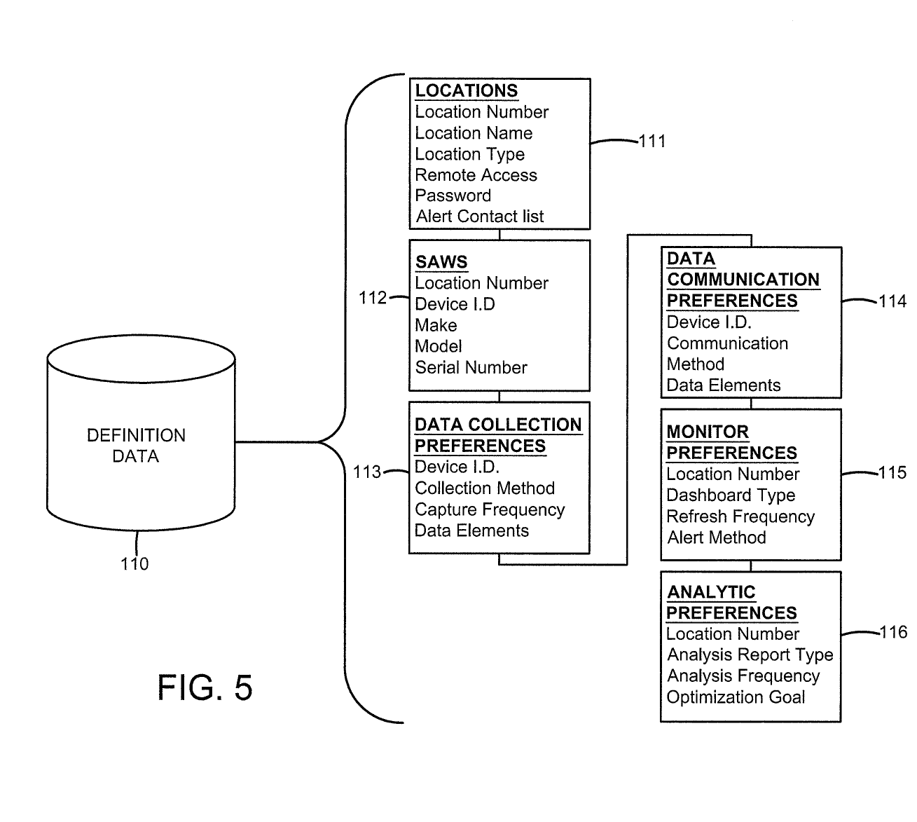

With additional reference to FIG. 5, examples of definitions 110 include: data elements that correspond to a physical location or locations 111 for saw(s) 10 employing saw data acquisition system 12; data elements that correspond to an identification 112 of each specific saw employing the saw data acquisition system; data elements that correspond to identification of which specific items of data are to be collected for processing and the frequency of collection 113, referred to as data collection preferences; data elements that correspond to preferences for communication 114 of information to and from each saw employing the saw data acquisition system, referred to as communication preferences; data elements that correspond to identification and display of saw parameters to be monitored 115 at central processing location 42; and data elements that correspond to identification of which performance aspects of the saw are to be analyzed 116, referred to as analytic preferences.

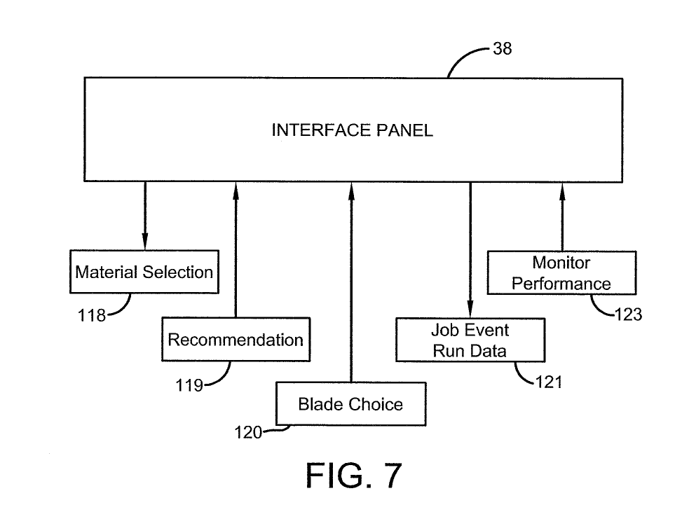

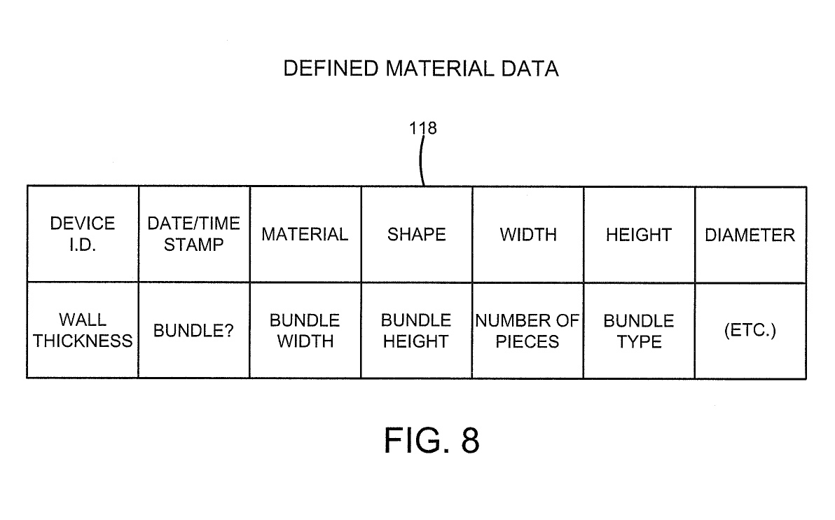

Referring now to FIGS. 3 and 7, once saw data acquisition system 12 has been configured with preparatory setup of information at central processing location, data from physical environment 117 of saw 10 may be input, and feedback may be provided to the operator of the saw. Such input preferably is performed through interface panel 38. For example, the operator of saw 10 employs interface panel 38 to input or define the material to be cut 118. Examples of data for the material to be cut 118 are shown in FIG. 8, and include shape, width, height, diameter, wall thickness, bundling, bundle height, number of pieces, bundle type, and other pertinent characteristics of the material.

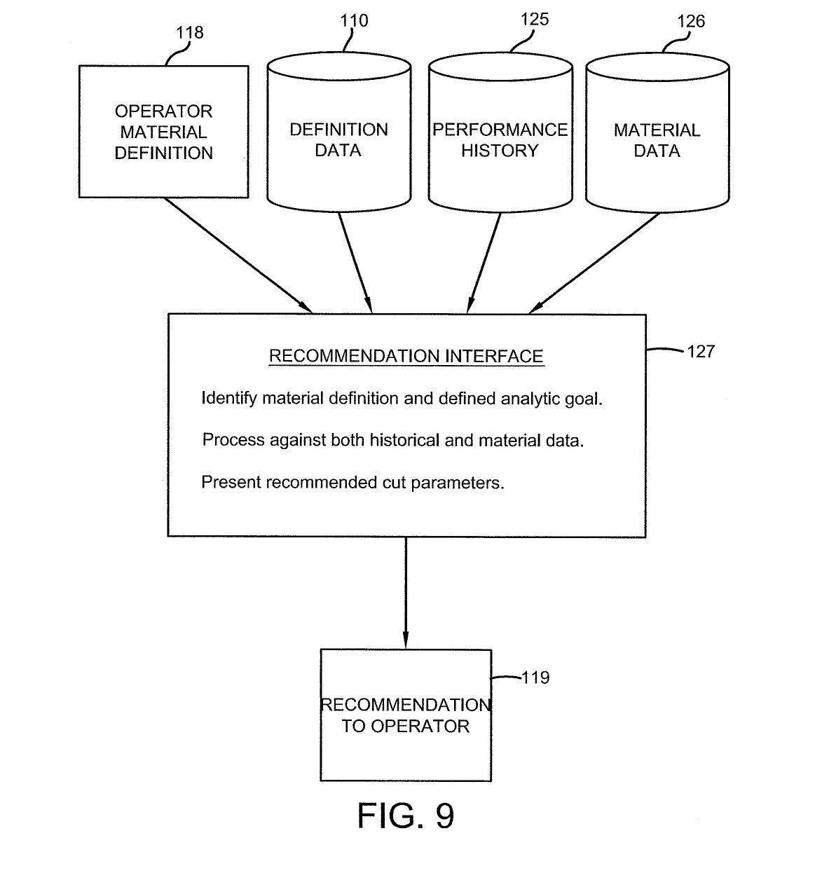

Returning to FIGS. 3 and 7, as will be described in greater detail below, the inputted data is transmitted to central processing location 42. At central processing location 42, the data is processed by an application such as Bladewizard®, which is a registered trademark of the M. K. Morse Company. For example, with additional reference to FIG. 9, the data regarding the material to be cut 118 is combined with definitional data 110, historical data 125 and application data 126, and is then processed 127. Central processing location 42 returns recommended cutting parameters or settings for saw 10, which are displayed 119 for the operator by interface panel 38.

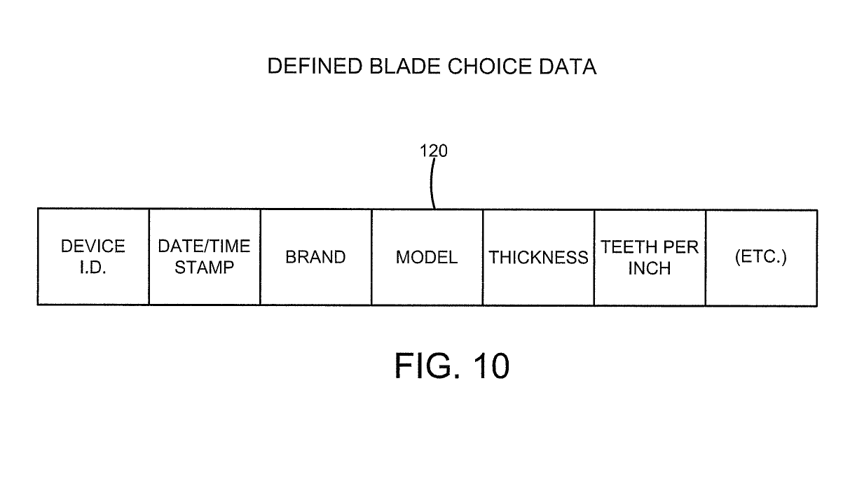

Referring to FIGS. 3, 7 and 10, using interface panel 38, the operator defines blade choice data 120 for the cutting operation. For example, blade data 120 may include the brand, model, thickness, teeth per inch, and other pertinent characteristics of the blade. The blade data is then transmitted to central processing location 42.

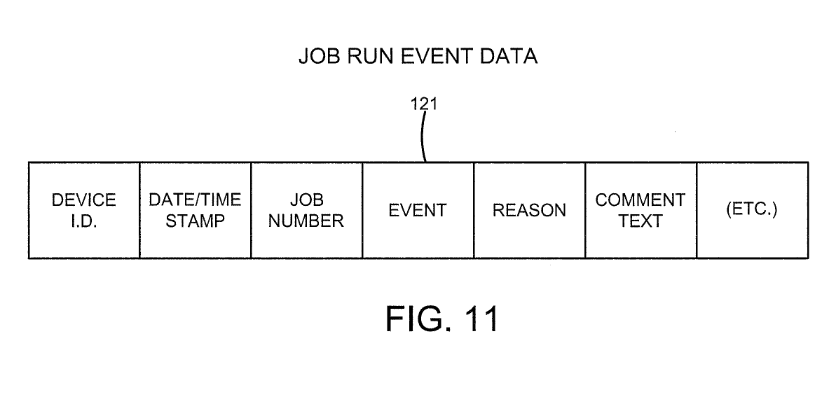

Turning to FIGS. 3, 7 and 11, during and upon the completion of the cutting operation, the operator periodically reports job run events 121 using interface panel 38, which are also transmitted to central processing location 42. Cutting operation events 121, which are also known as job run events, include the run start time, run stop time, blade changes, machine downtime and associated reasons.

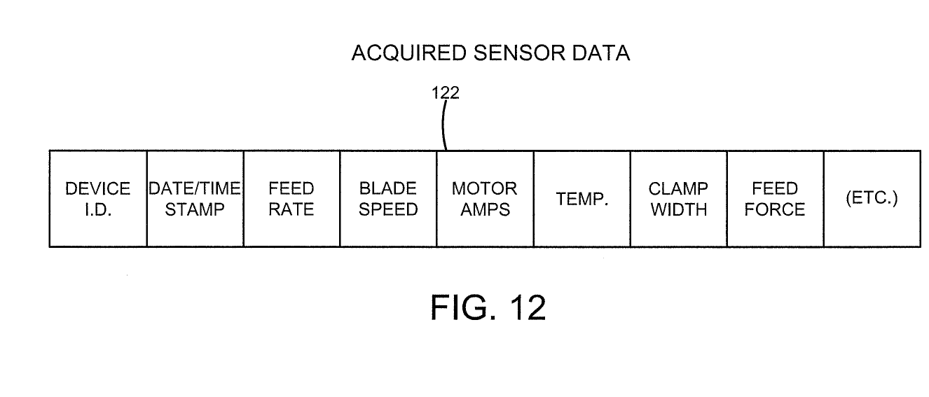

With reference to FIGS. 3, 7 and 12, during the cutting operation, the above-described sensor data is acquired 122 by local controller 40, which is transmitted to central processing location 42. Examples of acquired sensor data 122 include device/saw identification, date and time, feed rate, blade speed, motor amperage, temperature, clamp width, feed force, and any other pertinent parameters that are being measured by saw data acquisition system 12.

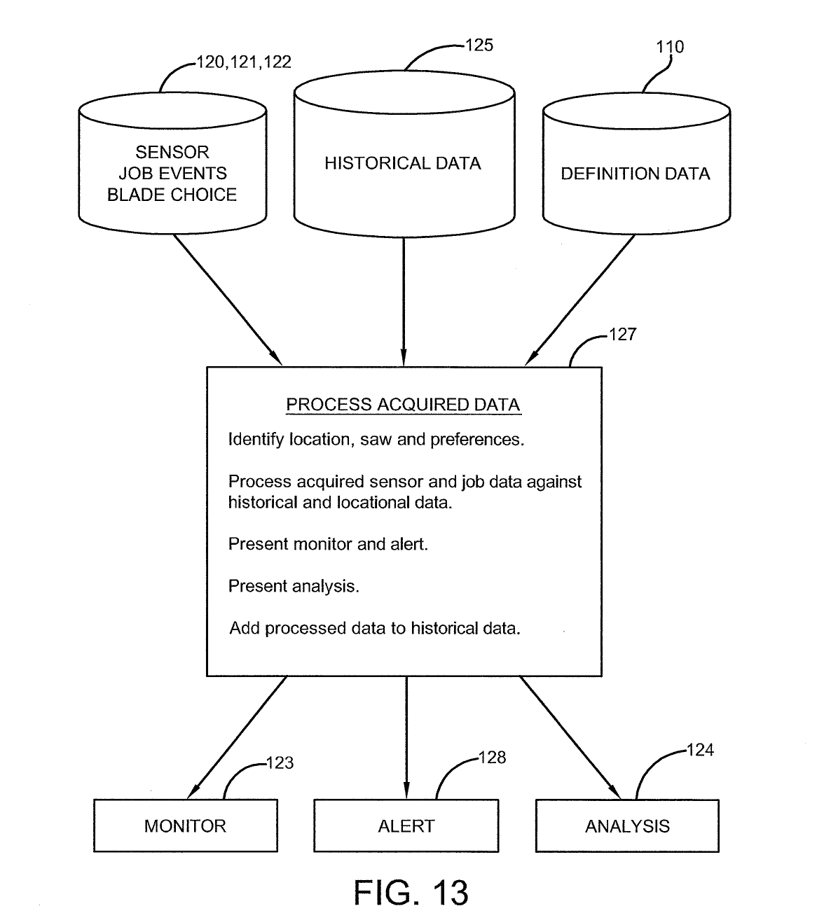

As will be described below, processor 80 at central processing location 42 receives the transmitted data and processes it, which enables saw data acquisition system 12 to monitor the cutting operation 123 and provide data analysis. Turning to FIGS. 3, 7, and 13, exemplary processing at central processing location 42 includes collating acquired sensor data 122 with job run event data 121 and blade choice 120, combining that data with historical data 125 and defined data 110, and processing this combined data 127. The resulting information or data allows local or remote monitoring 123, actuation of alerts 128, and analysis 124. In the processing, the data that is processed is also added to historical data 125, where it is taken into account for future processing. The monitored data may be displayed for the operator on interface panel 38, and the analysis results may be transmitted to interface panel 38 or another location, where they are received 124 and reviewed.

Returning to FIGS. 1 and 2, an optional feature that may be included in saw data acquisition system 12 is a menu (not shown) on interface panel 38 that enables the input of an email address or an address for a short message service (“SMS”), such as a text message address. In the event that one or more of the above-described sensors of saw data acquisition system 12 detects a condition that is programmed in controller 40 as an alert or emergency condition, the controller generates a message that is sent to the email or SMS address. For example, sensors may detect a breakage in saw blade 22, or a removal rate of material from workpiece 16 that is below a predetermined threshold, or the like, causing controller 40 to generate a message that is sent to the email or SMS address which has been input into interface panel 38, thereby alerting a supervisor, vendor, or other party as to the alert or emergency condition.

Another feature that may be included in saw data acquisition system 12 is the connection of controller 40 to a bar code scanner (not shown). The operator can use the bar code scanner to scan a bar code associated with workpiece 16 and/or saw blade 22, which automatically inputs the material type and other characteristics of the workpiece that are stored in the bar code, and the type of blade that is being used, to controller 40.

In addition, the information that is displayed on interface panel 38 may be in any selected language. Interface panel 38 preferably will have a menu (not shown) that enables the operator to change from English to any one of a number of pre-selected languages.

Optionally, a video camera (not shown) may be connected to controller 40. The camera would be directed to the area of saw blade 22 at workpiece 16 in order to record pictures or video of the saw blade cutting the workpiece, and storing the images on controller 40. The camera may be selectively engaged, so that a picture or video would be taken by the camera and recorded by controller 40 upon a change of saw blade 22, change of saw blade speed, an alert regarding operation of saw 10, and the like.

Via its electrical connection to interface panel 38, controller 40 acquires, collects, processes and stores the above-described data for transmittal to central processing location 42, as will be described below. It is to be understood that the above-described listing of data and parameters is exemplary and not exhaustive, and that other parameters may be monitored without affecting the overall concept or operation of the invention. For example, additional parameters that may be monitored on a band saw include: the temperature at the saw guide arms; the temperature of the coolant; the temperature of the material as measured after the cut; the width of the material measured at clamp or vise 18; and/or the height of the material as measured at the clamp. On a circular saw, parameters that may be monitored include: the revolutions per minute (“RPM”) of the motor shaft; the RPM of the blade; the feed rate; the time and date of the cutting operation; the amp draw of the motor; the temperature of the blade; and the temperature of the material being cut. In addition, saw data acquisition system 12 may optionally include a camera or laser system that would scan the cut surface to measure the area of the cut, and which may also measure the surface finish of workpiece 16 at the cut.

With particular reference to FIG. 2, local controller 40 acquires, collects, processes and stores the above-described data and parameters. The data is time-stamped, that is, assigned a time and date, by controller 40. Saw data acquisition system 12 transmits the data from controller 40 to central processing location 42 according to at least one of five different options.

The first option, indicated at 70, includes electrically transmitting the data from controller 40 through a wired Ethernet connection 72 to a router 74, which is electrically connected to Internet 76. The data is electrically transmitted through Internet 76, through a firewall 78 at central processing location 42, and to processors, such as servers 80, at the central processing location.

The second option, indicated at 82, includes sending a wireless electronic signal 84 from a wireless transmitter 86, which is electrically connected to controller 40, to a wireless receiver 88. Wireless receiver 88 is electronically connected to router 74, which is electrically connected to Internet 76. The data is electrically transmitted through Internet 76, through firewall 78 at central processing location 42, and to servers 80 at the central processing location.

The third option, indicated at 90, includes sending a wireless electronic signal 92 from wireless transmitter 86, which is electrically connected to controller 40, to a cellular network 94, such as a Global System for Mobile communication (“GSM”) or a Code Division Multiple Access (“CDMA”) network. The data is electronically transmitted through cellular network 94 to Internet 76, through firewall 78 at central processing location 42, and to servers 80 at the central processing location.

The fourth option, indicated at 96, includes sending a wireless electronic signal 98 from wireless transmitter 86, which is electrically connected to controller 40, to a selected smartphone or other device 100, which is connected to cellular network 94. The data is electronically transmitted through cellular network 94 to Internet 76, through firewall 78 at central processing location 42, and to servers 80 at the central processing location.

The fifth option, indicated at 102, includes directly connecting a portable data storage device 104, such as a flash memory device that includes an integrated Universal Serial Bus (“USB”) interface, to controller 40. When storage device 104 is directly connected to controller 40, data is copied to the storage device. Storage device 104 is then physically transported to servers 80 at central processing location 42, and connected to the servers to transfer the data to the servers.

An additional option (not shown), includes connecting controller 40 to a local personal computer (“PC”), and downloading the data from the controller to the PC. The PC is then connected over Internet 76 to central processing location 42 via a secured connection, such as a virtual private network (“VPN”). The data is then electronically transmitted from the PC over Internet 76, through firewall 78 at central processing location 42, and to servers 80 at the central processing location.

Data collected by controller 40 on band saw 10 is transmitted and thus copied to servers 80 at central processing location 42 for analysis. Servers 80 store and maintain the data for analysis. For example, the data is catalogued according to the location of saw 10, and the specific identity of the saw.

Once enough data has been captured, such as a time period of operation of saw 10 for one to three months, or some other regular interval, it is reviewed or mined. More particularly, each of the above-described parameters in the data is reviewed in order to indicate performance over time for saw 10, including the identity of the operator, the material being cut, its shape, the blade selected, and cutting parameters, such as feed rate, band speed, and the like. The data will indicate to an experienced reviewer aspects of the operation of saw 10 that may be improved, such as the use of a different saw blade 22, a different feed rate, and/or other parameters. Once the data has been reviewed or mined, analysis reports are generated that provide suggestions for operational improvements, and are displayed or printed via personal computing devices 106, which are presented to the owner or manager of saw 10.

Analysis reports that are displayed or printed via personal computing devices 106 enable the reviewer to make recommendations to the owner or operator of saw 10 on how to improve the operational efficiency and performance of the saw. In addition, analysis of the data may guide new product development efforts for particular characteristics of saw blade 22.

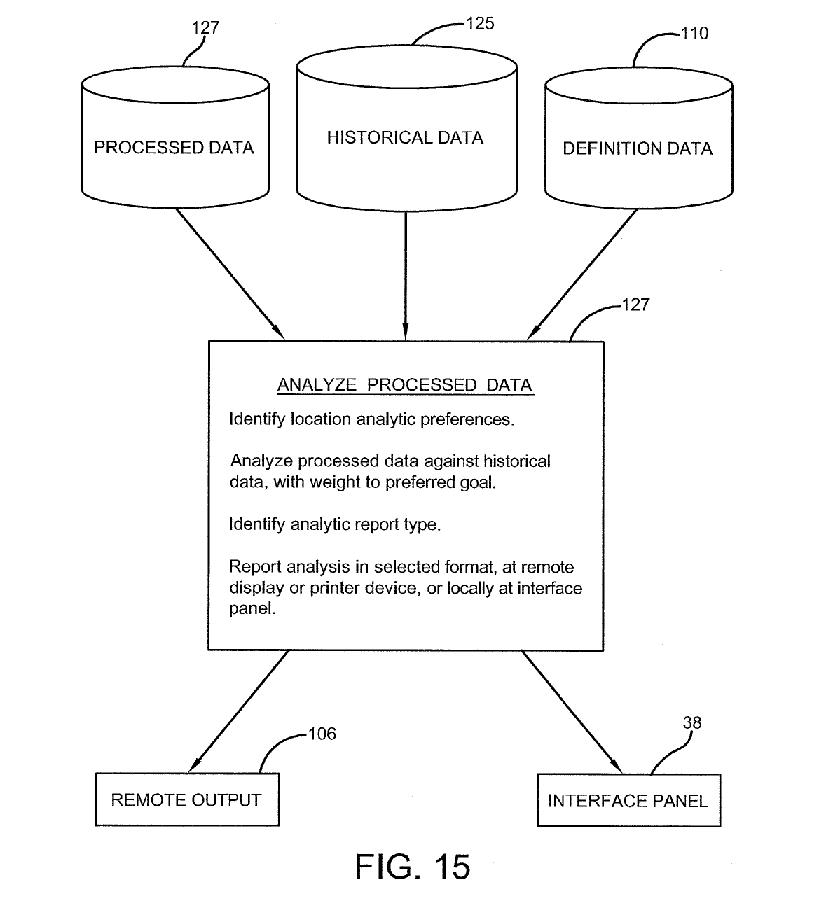

An exemplary analysis at central processing location 42 is shown in FIG. 15. Currently processed data 127 is collated with historical data 125 and defined data 110, giving weight to a defined goal. Depending upon the desired report type, the resulting analysis is presented either remotely 106 or locally via interface panel 38.

Examples of specific reports or displays 106 generated by saw data acquisition system 12 include simple productivity reports, which are reports on the time that saw 10 is active, and the number of cuts made by each blade 22. When combined with reports from other saws, this report will show available capacity and which machines are the busiest. System 12 may also generate advanced productivity reports, which are reports on what workpieces 16 have been cut on each saw 10. These reports indicate the square inches cut, pieces cut and hours on each saw 10 for the report period. Job optimization reports are reports that show the best cutting parameters for any given job, including material type, size, and type of blade combination. These reports give appropriate information to show which blade 22 works best in any given application for internal benchmarking.

System 12 may also generate black box reports, which show a historical report of what was cut and at what settings. These reports are useful when troubleshooting difficult applications or when there may be a problem with the blade or material being cut. Open source cutting reports are reports that employ data from several different saws 10, which enables a determination of best practices for any given material type. It is to be understood that any reports generated through the use of saw data acquisition system 10 may be in any selected language.

As a result, data from one or more saws 10 in one or more geographic locations is collected and transmitted to the central processing location 42, which enables the data to be analyzed and compared to a greater population. In this manner, trends in the data may become apparent, which enables analytical reports and displays 106 to be prepared that present the data with corresponding suggestions for operational improvement of each saw 10.

The above-described saw data acquisition system 12 of the present invention provides a system and method that employ sensors which detect specific data at saw 10 regarding the cutting operation, display the data for the operator, collect the data, transmit the data to the central processing location 42, acquire the data in the central processing location, and enable the data to be analyzed at the central processing location for guidance regarding optimum operation and efficiency of the saw. Saw data acquisition system 12 may be included as part of a new saw 10, or may be an upgrade or retrofit of an existing saw in the field.

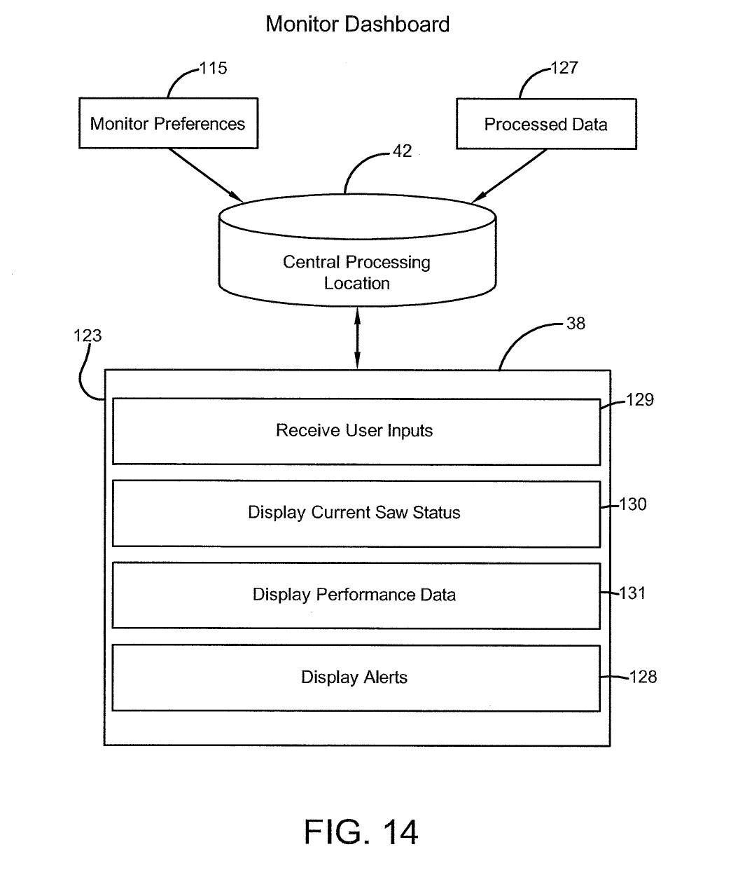

In addition to transmission of data to central processing location 42 for analysis, saw data acquisition system 12 includes an option to provide remote monitoring of real-time data from multiple locations and saws. More particularly, as shown in FIG. 2, controller 40 is connected to Internet 76 as described above. A computer (not shown) is also connected to Internet 76, and includes a central Web-based software dashboard. With additional reference to FIG. 14, an exemplary representation of the creation and presentation of monitor dashboards 123 is shown. Dashboards 123 may be viewed either locally or remotely. Processed data 127 is filtered through defined monitor preferences 115, to display saw status 130, performance data 131, and any alerts 128. The user or operator can interact and provide inputs 129 in a limited fashion to specify what data is displayed, especially when monitoring multiple saws.

The software dashboard on the computer receives data from a centralized data server (not shown) via the Internet 76. When a company employs a plurality of saws 10, the software dashboard receives the data from a centralized data server via the Internet 76 for each respective saw. The software dashboard provides a graphic view of all saw monitoring system outputs, and may include convenient status indicators such as green saw status indicator lights for operating saws and red status indicator lights for saws that are not operating. The software-provides links to other on-demand analysis services based on historical data to date. The software dashboard can thus be accessed via the web by a supervisor or manager, either locally or remotely, to see how all saws 10 are running at the current time. In this manner, the software dashboard of saw data acquisition system 12 enables real-time analysis and management of multiple saws 10.

The present invention also includes a method of operating a saw. The method includes steps in accordance with the description that is presented above and shown in FIGS. 1-15.

It is to be understood that the structure of the above-described saw data acquisition system and method of operating a saw may be altered or rearranged, or certain components omitted or added, without affecting the overall concept or operation of the invention. It is also to be understood that the present invention finds application in band saws, circular saws, and types of saws other than those shown and described herein and known to those skilled in the art, without affecting the concept or operation of the invention.

Accordingly, the improved saw data acquisition system and method of operating a saw are simplified, provide an effective, safe, inexpensive, and efficient structure which achieve all the enumerated objectives, provide for eliminating difficulties encountered with prior art saw monitoring systems, and solves problems and obtains new results in the art.

In the foregoing description, certain terms have been used for brevity, clarity and understanding; but no unnecessary limitations are to be implied therefrom beyond the requirements of the prior art, because such terms are used for descriptive purposes and are intended to be broadly construed. Moreover, the present invention has been described with reference to an exemplary embodiment. It shall be understood that this illustration is by way of example and not by way of limitation, as the scope of the invention is not limited to the exact details shown or described. Potential modifications and alterations will occur to others upon a reading and understanding of this disclosure, and it is understood that the invention includes all such modifications and alterations and equivalents thereof.

Having now described the features, discoveries and principles of the invention, the manner in which the improved saw data acquisition system and method of operating a saw are constructed, arranged and used, the characteristics of the construction and arrangement, and the advantageous, new and useful results obtained; the new and useful structures, devices, elements, arrangements, parts and combinations are set forth in the appended claims.

What is claimed is:

1. A method of operating a saw, said method comprising the steps of:
equipping a saw with at least one sensor;
acquiring data regarding the cutting operation using said at least one sensor;
transmitting said acquired data to a central processing location;
acquiring said transmitted data in said central processing location;
analyzing said acquired data;
generating recommendations for operation of said saw based on said analysis; and
incorporating said recommendations into said operation of said saw to optimize the operation and efficiency of the saw.

2. The method of operating a saw of claim 1, wherein said at least one sensor is a plurality of sensors.

3. The method of operating a saw of claim 2, where said data acquired using said plurality of sensors includes at least one of a feed rate of a blade of said saw, a linear speed of said saw blade, a power requirement of a drive motor for the saw, an air temperature adjacent a workpiece, and a width of clamp for securing said workpiece to said saw.

4. The method of operating a saw of claim 1, further comprising the step of inputting preparatory information for said saw operation into said central processing location.

5. The method of operating a saw of claim 4, wherein said preparatory information includes at least one of a physical location of said saw, an identification of the saw, data collection preferences, communication preferences, parameters to be monitored, and analytic preferences.

6. The method of operating a saw of claim 1, further comprising the step of receiving at said central processing location data from an operator of said saw regarding a material to be cut by the saw.

7. The method of operating a saw of claim 6, wherein said data from said operator is input through an interface panel.

8. The method of operating a saw of claim 6, wherein said data from said operator includes at least one of a shape of said material to be cut, a width of the material to be cut, a height of said material to be cut, a diameter of the material to be cut, a wall thickness of said material to be cut, any bundling of the material to be cut, a height of a bundle of said material to be cut, a number of pieces in a bundle of the material to be cut, and a type of bundle of said material to be cut.

9. The method of operating a saw of claim 6, further comprising the steps of:
evaluating said data from said operator regarding a material to be cut by said saw at said central processing location; and
returning recommended cutting parameters from said central processing location to an interface panel at said saw.

10. The method of operating a saw of claim 1, further comprising the step of receiving at said central processing location data from an operator of said saw regarding a cutting blade choice.

11. The method of operating a saw of claim 1, wherein said blade choice data includes a brand of said cutting blade, a model of the cutting blade, a thickness of said cutting blade, and a number of teeth per inch of the cutting blade.

12. The method of operating a saw of claim 1, further comprising the step of receiving at said central processing location data from an operator of said saw regarding cutting operation events.

13. The method of operating a saw of claim 12, wherein said cutting operation event data includes at least one of a cutting operation start time, a cutting operation end time, changes of a cutting blade, and machine down time.

14. The method of operating a saw of claim 1, wherein at least some of said acquired data is displayed for an operator of said saw.

15. The method of operating a saw of claim 1, wherein said step of analyzing said acquired data includes collating currently processed data with historical data and defined data.

16. The method of operating a saw of claim 1, wherein said step of generating recommendations for operation of said saw includes producing at least one of a productivity report, a job optimization report, a black box report, and an open source cutting report.

17. The method of operating a saw of claim 1, wherein said method includes operating more than one saw.

18. The method of operating a saw of claim 17, wherein said saws are disposed at different geographic locations.

19. The method of operating a saw of claim 1, further comprising the step of monitoring said saw operation from a remote location.

20. The method of operating a saw of claim 1, wherein said method is performed by a saw data acquisition system.

21. A saw data acquisition system, said system comprising:
at least one sensor being operatively connected to a saw;
an interface panel being operatively connected to said saw;
a central processing location;
means for transmitting data acquired by said at least one sensor and data input into said interface panel to said central processing location;
said central processing location including a storage medium for storing said transmitted data; and
means for analyzing said transmitted data and providing recommendations for operation of said saw based on the analysis.
